(19) United States
(12) Patent Application Publication
(10) Pub. No.: US 2026/0330524 A1
(43) Pub. Date: Oct. 22, 2026

(54) COSMETICS INFORMATION SYSTEM

(71) Applicant: Kireii Co., Ltd., Tokyo (JP)

(72) Inventor: Mayumi Horii, Tokyo (JP)

(21) Appl. No.: 19/120,396

(22) PCT Filed: Oct. 12, 2023
(86) PCT No.: PCT/JP2023/037105

§ 371 Date: Apr. 3, 2026

(30) Foreign Application Priority Data
Oct. 12, 2022 (JP) 2022164367

(51) Int. Cl. G06Q 30/0601; G06F 3/0482

(52) U.S. Cl. CPC G06Q 30/0627; G06F 3/0482

(57) ABSTRACT

The cosmetic information system of the present invention is provided with an ingredient display screen generation means that generates an ingredient display screen which cosmetic information including the name of a cosmetic product and the name of an ingredient, and cosmetic extraction means that extracts cosmetic information corresponding to the selected item from the cosmetic information registered in the cosmetic database, and when at least one of the ingredient names included in the first cosmetic information indicated by the ingredient display screen is selected, the system extracts the second cosmetic information corresponding to the selected ingredient, and displays the ingredient display screen, having the first and second cosmetic information on the display means.

### TECHNICAL FIELD

This invention relates to a cosmetic information system that can compare commercially available cosmetic with each other based on information about the ingredients contained in the cosmetic. The term “cosmetic” as used in this application does not only refer to cosmetic (including quasi-drugs and drugs) such as beauty solution, creams, and other cosmetic such as lipstick, but also refer to other products such as soap, facial cleanser, shampoo, hair conditioner, hair treatment, lotion, body shampoo, hair cosmetic, face masks, cleansing oil, toothpaste, perfume, hair growth tonic, bath additives, etc., which may come into contact with the skin or hair when used.

### BACKGROUND TECHNOLOGY

Many users have trouble in choosing which of many cosmetic on the market to use on a daily basis. In particular, when it comes to cosmetic that require consideration of the condition of the skin, etc., there is a high risk of purchasing a product that does not suit the user if they choose and purchase it themselves, compared to face-to-face sales at a store where skin diagnosis and other counseling is provided.

In relation to the above problem, there are systems that provide information on cosmetic and evaluate cosmetic. For example, Patent Document 1 discloses a cosmetic evaluation information analysis system. This system accumulates in a database quantitative and non-quantitative cosmetic evaluation information and user attribute information entered by users from multiple contributor terminals, creates analysis charts of the quantitative cosmetic evaluation information accumulated in the database, and, based on the cosmetic analysis conditions received from the user terminal, associates the non-quantitative cosmetic evaluation information and user attribute information with the relevant analysis charts and transmits them to the user terminal. According to this cosmetic evaluation information analysis system, users can obtain their own evaluation information analyzed based on various indicators, and it is also possible to search for the most suitable product based on the cosmetic evaluation information of users with similar attributes to their own.

However, the system disclosed in Patent Document 1 searches for the optimal product based on the attributes and subjective opinions of the contributor, and does not search for it based on the ingredients contained in the cosmetic. Therefore, this system does not show the user the relationship between the optimal product and the ingredients contained in that product.

In addition, the information processing device disclosed in Patent Document 2 obtains counseling information including answers about the user's skin problems, selects a first candidate cosmetic product based on the obtained counseling information, selects a second candidate cosmetic product based on related information that associates cosmetic and skin problems using a predetermined evaluation index and the user's skin problems, and recommends the optimal cosmetic product to the user based on the first and second candidate cosmetic products. This system uses an evaluation index based on the ingredients of the cosmetic product to select the second candidate cosmetic product.

Recently, it has become possible to easily obtain not only commercial information that promotes commercial products, but also information on the ingredients contained in cosmetic and their effects on the skin. In addition, it has become possible to see word-of-mouth communication information on cosmetic in sales sites of the Internet. Therefore, there is a demand from users who want to choose cosmetic based on ingredient information that can be obtained on the Internet, brand preferences, and trends.

The information processing device disclosed in Patent Document 2 makes recommendations that are not based solely on subjective grounds, so that this information processing device can be considered to be a system equivalent to an experienced salesperson in face-to-face sales. However, this information processing device does not respond to the user's request to be able to choose their own preferred cosmetic.

Gathering information on the ingredients of many cosmetic is laborious. In addition, cosmetic usually contain many ingredients, and it is not easy to compare them between cosmetic products. These things make it difficult for users to choose cosmetic that suit them.

### PRIOR ART DOCUMENTS

### Patent Documents

Patent Document 1: JP 2005-235139 A

Patent Document 2 U.S. Pat. No. 7,121,876

### SUMMARY OF THE INVENTION

### Problem to be Solved by the Invention

This invention was made in view of the above points, and its purpose is to provide a cosmetic information system that allows users to easily search for other cosmetic containing the ingredients they have selected, from the ingredients contained in a single one cosmetic product, and to compare information on a single cosmetic product with information on other cosmetic products on a screen.

### Means for Solving the Problem

The cosmetic information system of the present invention includes:
an ingredient display screen generation means (32) that generates an ingredient display screen (60, 80) which shows cosmetic information including information on the ingredient names corresponding to at least the product names of the cosmetic;
an output unit (12) that outputs the data of the ingredient display screen (60, 80) generated by the ingredient display screen generation means (32) to a display means (22) for displaying the ingredient display screen (60, 80);
an input unit (11) that accepts input of the selected items selected on the ingredient display screens (60, 80) displayed on the display unit (22);
a cosmetic extraction unit (31) that accesses the cosmetic database (41) in which cosmetic information is registered for each cosmetic product and extracts the cosmetic information corresponding to the selected items accepted by the input unit (11) from the cosmetic information registered in the cosmetic database (41); and,
when at least one of the ingredient names (61d) contained in the first cosmetic information (61a-61f), which is one of the cosmetic information items shown on the ingredient display screen (60a) displayed on the display means (22), is selected,
the selected ingredient name is input to the cosmetic extraction means (31) as the selected item,
and the cosmetic extraction means (31) extracts the second cosmetic information (62a to 62f), which is cosmetic information other than the first cosmetic information, from among the cosmetic information registered in the cosmetic database (41), based on the selected items inputted,
and the ingredient display screen generation means (32) generates other ingredient display screens (60b, 60c) that have the first cosmetic information (61a-61f) and the second cosmetic information (62a-62f) extracted by the cosmetic extraction means (31),
and the output unit (12) outputs the data of said other ingredient display screens (60, 80) to the display means (22).

According to the present cosmetic information system, a user can easily search for a second cosmetic product that contains a selected ingredient from the ingredients contained in a first cosmetic product, and compare the information on the first cosmetic product and the information on the second cosmetic product on a screen displayed on a display device. Therefore, for example, a user can easily find an alternative candidate cosmetic product (other cosmetic product) that has the same ingredients as a cosmetic product (first cosmetic product) that is currently being used without any skin problems or other issues.

The system of the present invention further has an item-by-item selection screen generating means (34) for generating an item-by-item selection screen (55) including at least one of a category (55e), a brand (55d), a predetermined component (55a, 55b), and a predetermined product (55c) as the selection items, and each of the selection items includes at least one search item; and each of the cosmetic information further includes the category (55e) and/or brand (55d) to which each cosmetic product belongs, and when at least one of the search items is selected on the item-by-item selection screen (55) displayed on the display means (22), the cosmetic extraction means (31) can be configured to extract the cosmetic product information corresponding to the search item from among the cosmetic product information registered in the cosmetic product database (41). In this way, for example, by selecting a cosmetic product that is attracting attention in the market (a predetermined product) as a selection item, a user who wants to examine a cosmetic product included in the search item can easily select the cosmetic product (the first cosmetic product) that they want to compare. Also, by selecting a category, brand, or ingredient that is attracting attention in the market (a predetermined ingredient) as a selection item, the first cosmetic product can be easily selected by narrowing down the selection from the category or brand.

In addition, in the system of the present invention, the ingredient display screen generation means (32) can generate an ingredient display screen (60a) that shows the ingredient information corresponding to the search item extracted by the cosmetic extraction means (31) as the first cosmetic information (61a to 61f). In this way, if only one cosmetic product is extracted by the cosmetic product extraction means, the ingredient display screen showing the first cosmetic product information can be immediately displayed on the display means.

In addition, the system of the present invention further comprises a list display screen generation means (33) that generates a list display screen (70a) which displays the product name (71e) of the cosmetic contained in the cosmetic information corresponding to the search item extracted by the cosmetic extraction means (31) in table (71a) format, and
when one of the links (71f) for the cosmetic whose product names (71e) are displayed on the list display screen (70a) displayed on the display means (22) is selected, the ingredient display screen generation means (32) can make the cosmetic information for the selected cosmetic the first cosmetic information and generate an ingredient display screen (60a) that shows the cosmetic information. In this way, if there are two or more cosmetic extracted by the cosmetic extraction means, the extracted cosmetic are displayed in the list, and the user can select one from the listed cosmetic and display it as the first cosmetic on the ingredient display screen.

In addition, in the system of the present invention, when at least two of the cosmetic whose product names (71e) are displayed on the list display screen (70a) displayed on the display means (22) described above are selected, the ingredient display screen generation means (32) can generate an ingredient display screen (80a) that shows the ingredient information (81a to 81f) for each of the at least two selected cosmetic. In this way, the user can easily compare the information of multiple cosmetic on the ingredient display screen.

In this case, the ingredient display screen generation means (32) can generate an ingredient display screen (80a) with an additional common ingredient display unit (82) that displays the ingredients which are common to all of the displayed cosmetic. In this way, the user can easily check the ingredients that are common to all of the displayed cosmetic on the ingredient display screen.

In addition, in the system of the present invention, when the ingredient display screen (80a) showing the each cosmetic information (81a to 81f) of at least two of the selected cosmetic is displayed on the display means (22), if at least one of the ingredient names (81d) shown on the ingredient display screen (80a) displayed on the display means (22) is selected, the ingredient display screen generation means (32) can display the selected ingredient name and the same ingredient name as the selected ingredient name in such a manner that they are allowed to be distinguished from other ingredients. In this way, the user can easily check on the ingredient display screen the selected ingredient is contained in which of the multiple cosmetic.

In addition, in the system of this invention, the list display screen (70a) has an exclusion ingredient input unit (73a) that can be used to input exclusion ingredients, which are ingredients that the user wants to exclude from the ingredients contained in the cosmetic, and when the excluded ingredients are input in the excluded ingredient input unit (73a), the list display screen generation means (33) narrows down the cosmetic information corresponding to the selected items to the cosmetic information of the cosmetic that do not contain the excluded ingredients, and the narrowed-down cosmetic information can be displayed on the list display screen (70a). By configuring it in this way, the user can exclude the cosmetic that contain the ingredients they want to avoid, such as those that do not suit their skin, on the list display screen.

In addition, in the system of the present invention, when at least one of the ingredient names (61d) included in the first cosmetic information (61a to 61f) of the ingredient display screen (60a) displayed on the display means (22) is selected, the ingredient display screen generation means (32) can display the selected ingredient name in such a manner that it is allowed to be distinguished from other ingredient names. In this way, the user can easily check which of the multiple cosmetic contains the selected ingredient on the ingredient display screen.

In addition, in this system, based on the information entered by the user, the cosmetic that the user is not good at are determined, and information is formed for the user to select whether or not the user's impression of the safe products that have been pre-registered as highly safe cosmetic is positive, and the cosmetic diagnosis means (35) is further included for extracting, from the cosmetic information registered in the cosmetic database, the ingredients that are not included in the safe products for which the user has a positive impression, and are included in the cosmetic for which the user has a negative impression, serving as the ingredients that the user has a negative impression, based on the results of the cosmetic impression survey which are input via the cosmetic impression survey screen displayed on the user's terminal. In this way, even if the user does not know which “unfriendly ingredients” may be contained in cosmetic, the user can easily and quickly find products that suit them.

### Effects of the Invention

In the cosmetic information system of this invention, the user can easily search for other cosmetic that contain ingredients selected from the ingredients contained in one cosmetic, and compare the information on one cosmetic with the information on the other cosmetic on a screen displayed in a display device.

### BRIEF EXPLANATION OF THE DRAWINGS

FIG. 1 is a system configuration diagram of the first embodiment of the present invention, showing a cosmetic information system.

FIG. 2 is a block diagram of the server and user terminal of the first embodiment of the present invention, showing a cosmetic information system.

FIG. 3 is an example of a web page including a selection screen showing search items by category.

FIG. 4 is an example of an ingredient display screen showing the first cosmetic product extracted by search and other cosmetic product containing the active ingredients contained in the first cosmetic product, effecting a comparison between these products.

FIG. 5 is an example of an ingredient display screen that displays the first cosmetic product, other cosmetic products that contain the selected ingredient, and further cosmetic products that do not contain the selected ingredient in a way that allows comparison.

FIG. 6 is an example of an ingredient display screen that displays the first cosmetic product, other cosmetic products that contain the two selected ingredients, and further cosmetic products that do not contain the two selected ingredients in a way that allows comparison.

FIG. 7 is an example of a list display screen that displays a list of two or more extracted cosmetic products in tabular form.

FIG. 8 is an example of a list display screen showing a condition where the user has selected multiple cosmetic to compare.

FIG. 9 is an example of an ingredient display screen that is displayed instead of the list display screen when the comparison of the multiple cosmetic selected by the user is executed.

FIG. 10 is an example of an ingredient display screen that is displayed when an ingredient common to all of the cosmetic to be compared is selected.

FIG. 11 is an example of a list display screen that displays in table form the two or more cosmetic extracted by search.

FIG. 12 is a system configuration diagram of the second embodiment of the present invention's cosmetic information system.

FIG. 13 is a block diagram of the server and user terminal of the second embodiment of the present invention's cosmetic information system.

FIG. 14 is an example of a web page including a selection and start screen for the cosmetic diagnosis.

FIG. 15 is an example of a web page including a screen for executing step 1 of the cosmetic diagnosis.

FIG. 16 is an example of a web page including a screen for executing step 2 of the cosmetic diagnosis.

FIG. 17 is an example of a web page that includes a screen for executing step 3 of the cosmetic diagnosis.

FIG. 18 is an example of a web page that includes a screen for displaying a report of the cosmetic diagnosis results.

### EMBODIMENTS FOR IMPLEMENTING THE INVENTION

### First Embodiment

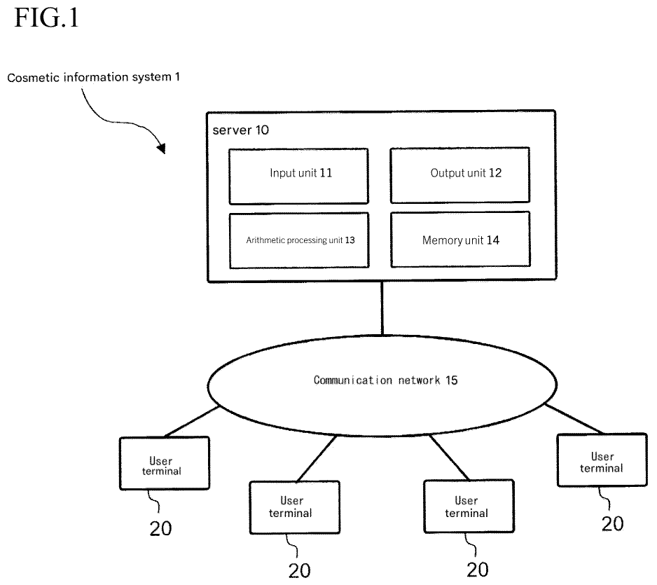

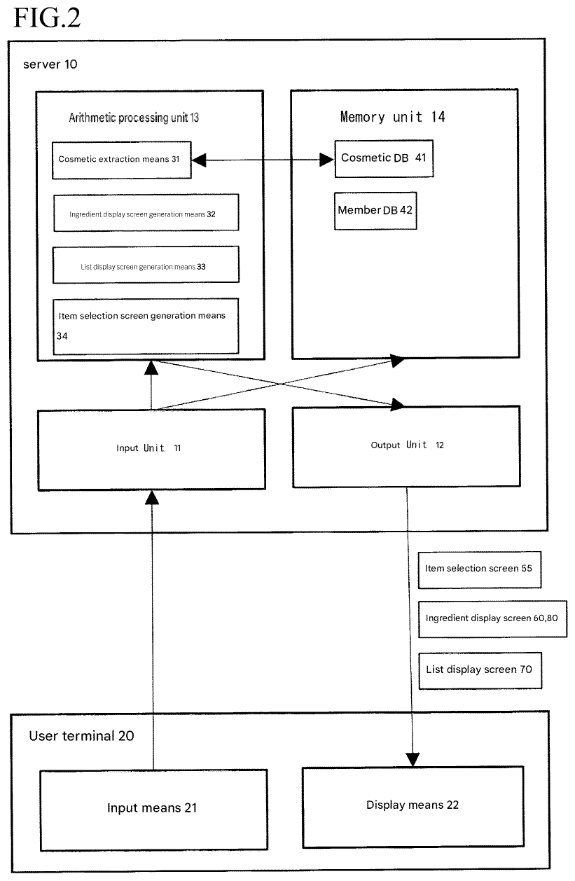

The following describes the first embodiment of the present invention, a cosmetic information system, with reference to the attached drawings. FIG. 1 is a system configuration diagram of the first embodiment of the present invention, a cosmetic information system. FIG. 2 is a configuration diagram of the server and user terminal that make up the cosmetic information system. In this embodiment, the system is explained using an example that mainly targets cosmetic (including quasi-drugs) such as beauty serums, creams, and lipsticks, among all types of cosmetic.

As shown in FIG. 1, the cosmetic information system 1 comprises a server 10 connected to at least one user terminal 20 via a communication network 15 such as the Internet and/or an intranet. The server 10 and user terminal 20 are connected so that they can send and receive information to and from each other.

The server 10 is a web server that provides HTML and object display to the web browser running on the user terminal 20. The server 10 provides detailed information on cosmetic, including information on ingredients, information on cosmetic that contain or do not contain the ingredients specified by the user, and information on comparing ingredients between multiple cosmetic, in response to requests from the user terminal 20.

The server 10 is configured as a computer including a processor such as a CPU, a main memory such as RAM, a secondary memory such as a HDD, SSD, or DVD, a wired or wireless communication device, an input device such as a keyboard or mouse, and a display device such as a display. The program installed in the server 10, which is configured as a computer, makes the computer to realize the functions described below. Server 10 does not necessarily have to be composed of only one computer, and it may be a case where multiple computers work together to achieve the functions described below.

Server 10 is provided with an input unit 11, an output unit 12, an arithmetic processing unit 13, and a memory unit 14. The input unit 11 accepts information input directly into server 10 by the input device described above. The input unit 11 also accepts information input from user terminal 20 via communication network 15. The input unit 11 inputs the accepted information into the arithmetic processing unit 13 and the memory unit 14. The output unit 12 distributes (outputs) information to the user terminal 20 for displaying the calculation results generated by the arithmetic processing unit 13. The arithmetic processing unit 13 generates information to be provided to the user terminal 20 using the information input from the input unit 11 and the information stored in the memory unit 14.

The user terminal 20 is configured as a computer that includes a processor such as a CPU, a main memory such as RAM, a secondary memory such as a HDD, SSD, or DVD, a wired or wireless communication device, an input device such as a keyboard or mouse, and a display device such as a display. It is not limited to a stationary computer, and can also be used with portable terminals such as tablet terminals and smartphones.

In the user terminal 20 configured as a computer, at least the functions described below are implemented by the installed operating system (OS). The OS causes the user terminal 20 to execute a function that accepts input of information from the input device. Therefore, the user terminal 20 is provided with an input means 21 that accepts input of information and data. The OS also causes the user terminal 20 to execute a function that displays information input by the input means 21 and information transmitted from the server 10 on the display device. Therefore, the user terminal 20 is equipped with a display means 22 that displays the input information and the like as text or images.

A web browser that operates on the OS is installed in the user terminal 20. By the user specifying the URL of the website constructed on the server 10 in the web browser, the user terminal 20 can access the server 10.

Using the block diagram shown in FIG. 2, the configuration of the arithmetic processing unit 13 and memory unit 14 of the server 10 is explained in detail. The arithmetic processing unit 13 has a cosmetic extraction means 31, an ingredient display screen generation means 32, a list display screen generation means 33, and a item-by-item selection screen generation means 34. The memory unit 14 has a cosmetic database (cosmetic DB) 41 and a member database (member DB) 42.

First, we will explain the memory unit 14. The cosmetic database 41 has detailed information (cosmetic information) about each cosmetic product disclosed by the cosmetic distributor. This cosmetic information includes the appearance image of the cosmetic, product name, category, active ingredients, ingredients, brand, distributor, price, capacity, and release date, and the like. Other information may also be included, such as whether or not the cosmetic in question are organic (i.e. cosmetic whose main ingredients are plant ingredients grown using organic methods), or whether or not animal testing was carried out during development or manufacturing. The member database 42 has member information for members who use the cosmetic information system 1. This member information includes the member's ID, login password, and contact information (e-mail address, telephone number, etc.).

Next, we will individually explain the cosmetic extraction means 31, the ingredient display screen generation means 32, the list display screen generation means 33, and the item-by-item selection screen generation means 34 of the arithmetic processing unit 13.

The cosmetic extraction means 31 accesses the cosmetic database 41 and searches for cosmetic information registered in the cosmetic database 41 by using the product name, category, ingredients, brand and the like, input from the input means 21 as keys, and extracts the cosmetic information that has been hit. The cosmetic extraction means 31 then outputs the extracted cosmetic information to the ingredient display screen generation means 32 or the list display screen generation means 33.

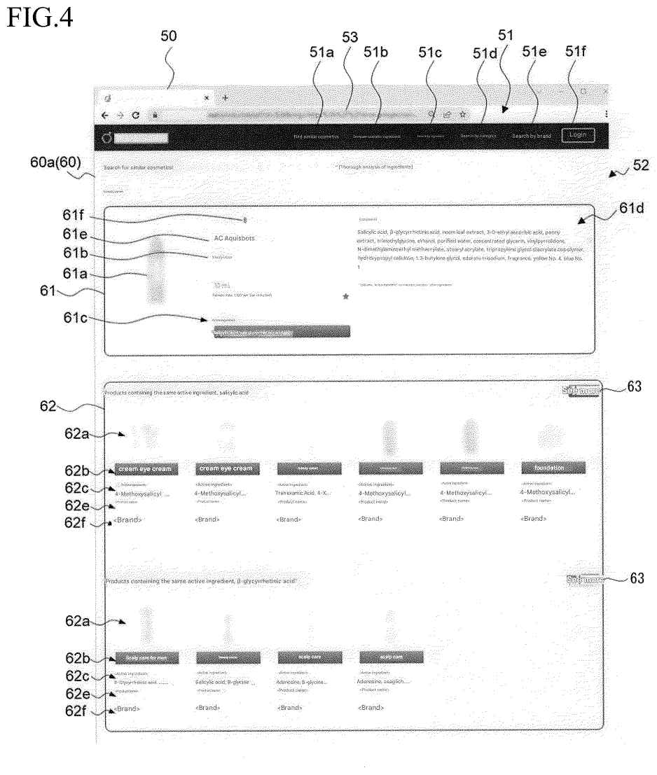

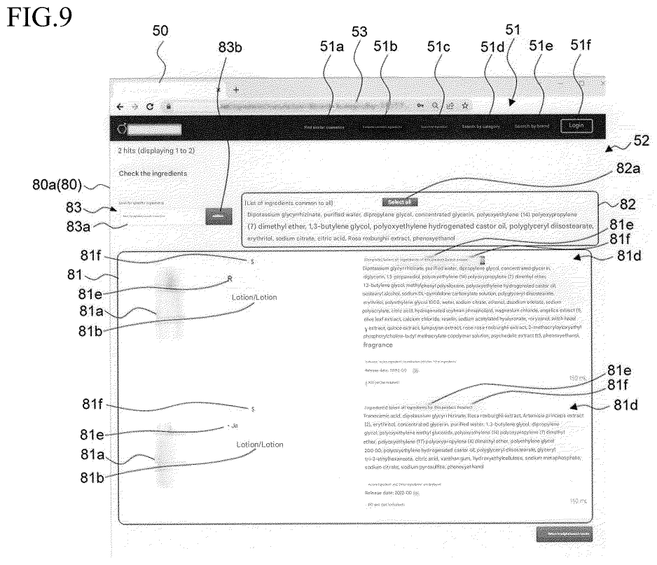

The ingredient display screen generation means 32 generates screen information (ingredient display screens 60, 80) for displaying the cosmetic information for at least one cosmetic product output from the cosmetic extraction means 31 in a predetermined layout. The web browser on the user terminal 20 that receives the data for the ingredient display screens 60, 80 displays the cosmetic information formatted in the predetermined layout. Specifically, the appearance image of the cosmetic, product name, category, active ingredient name, ingredient name, brand, and distributor, etc., are displayed in a format similar to the layout shown in FIGS. 4 and 9.

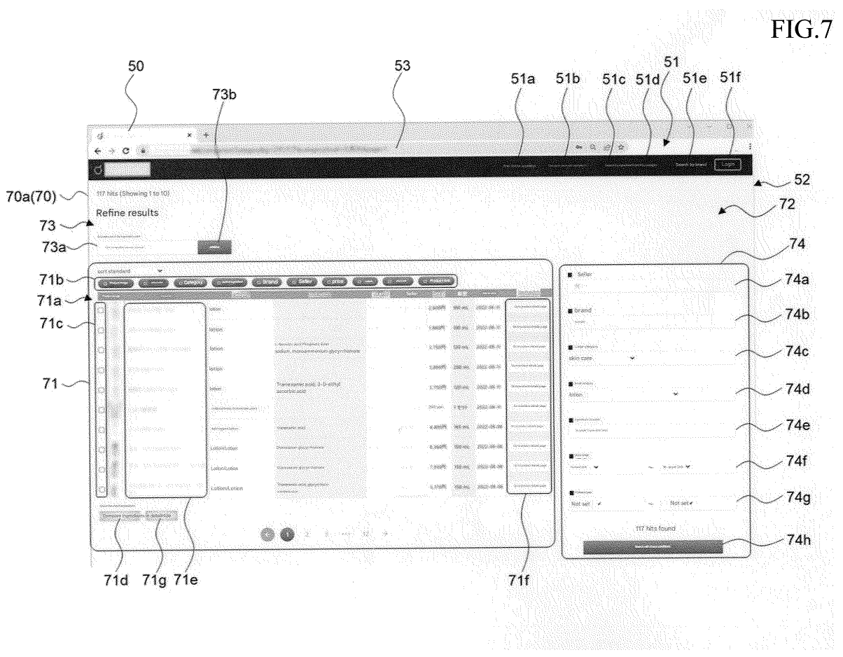

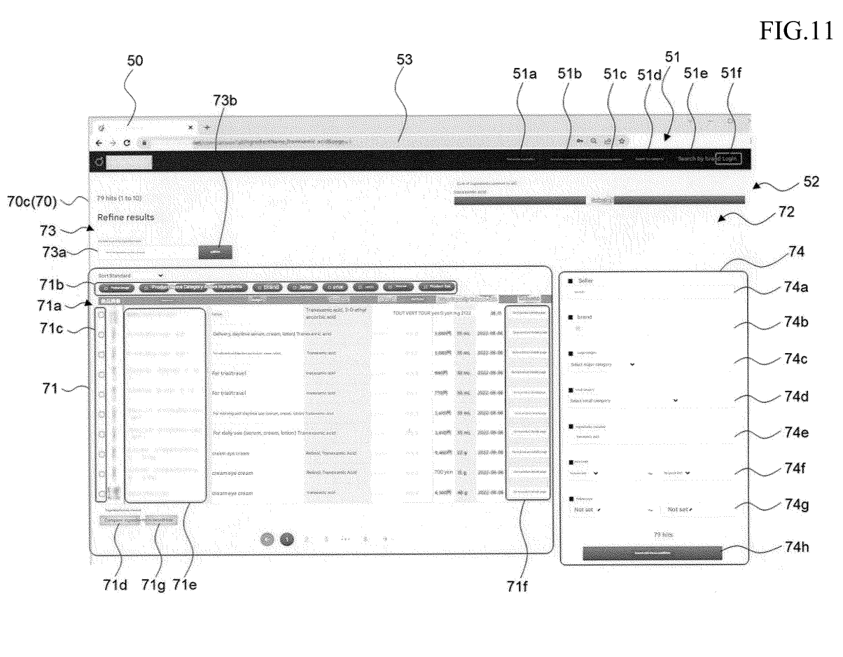

The list display screen generation means 33 generates screen information (list display screen 70) that includes a table for displaying list of cosmetic information for at least one cosmetic product output from the cosmetic extraction means 31. The web browser of the user terminal 20 that has received the data for the list display screen 70 displays the cosmetic information formatted in a predetermined tabular format. Specifically, the cosmetic appearance image, product name, category, active ingredients, ingredients, brand, and distributor, etc., are formatted and displayed in a layout similar to those shown in FIGS. 7 and 11.

The item-by-item selection screen generation means 34 generates the screen information (item-by-item selection screen 55) for the user interface for inputting the search items (product name, category, ingredients, and brand) by using the input means 21. The item-by-item selection screen 55 is configured so as to display multiple search items that can be selected for each category, brand, prescribed ingredient, and prescribed product. The search items selected using the input means 21 are output to the cosmetic extraction means 31.

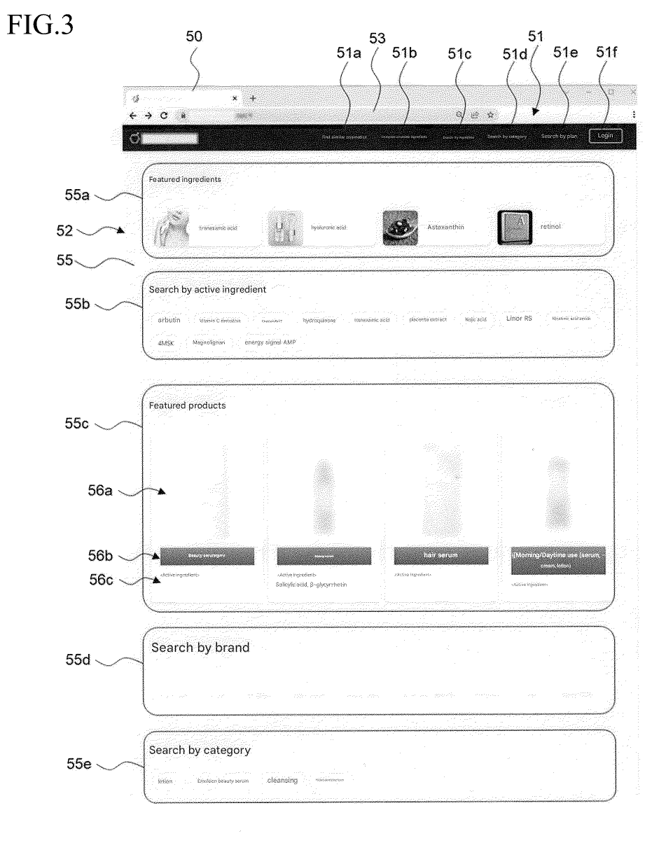

FIGS. 3 to 11 show specific examples of screens displayed on the display device of the user terminal 20. The following describes the first embodiment of the cosmetic information system of the present invention using the specific examples of screens.

When the user starts up a web browser on the user terminal 20 and enters a predetermined URL in the URL input field 53, the web page 50 of the server 10 is displayed in the web browser. Web page 50 includes a menu bar 51 and a content area 52. When the user selects the login button 51f in the menu bar 51, a login screen (not shown) is displayed. By entering their member ID and password on this login screen, the user can log in and thereby receive the services of the cosmetic information system.

The menu bar 51 is always displayed on all pages of the cosmetic information system 1. The menu bar 51 has separate options for different purposes, such as “find similar cosmetic” 51a, “compare cosmetic ingredients” 51b, “search by ingredient” 51c, “search by category” 51d, and “search by brand” 51e. When the user selects one of these options, the display screen will move to another part of the page or to another page according to the purpose.

As shown in FIG. 3, the top page of the web page 50 displays the item-by-item selection screen 55 in the content area 52. The item-by item selection screen 55 arranges the search items by each items, such as “featured Ingredients” 55a, “search by active ingredients” 55b, “featured products” 55c, “search by brand” 55d, and “search by category” 55e. The search items for each item are set by the system administrator. “Featured ingredients” 55a and ‘active ingredients’ 55b correspond to the ‘prescribed ingredients’ of the present invention. In addition, ‘featured products’ 55c corresponds to the ‘prescribed products’ of the present invention.

The search items in “search by category” 55e are terms for the “major categories” that broadly classify cosmetic. In order to make it easier for users to recognize which product (cosmetic) they are looking at, the appearance photos of cosmetic 56a, “minor categories” 56b, and active ingredients 56c are displayed at each selection items within the “featured products” 55c. The “minor categories” are terms that subdivide the “major categories”.

Here, by using FIGS. 3 to 6, we will explain an example in which the user selects the second cosmetic product from the left in the “featured products” 55c on the item-by-item selection screen 55 shown in FIG. 3. The second cosmetic product from the left is a beauty essence that contains “salicylic acid” and “beta-glycyrrhetinic acid” as active ingredients. When the user selects this beauty essence, the display in the content area 52 switches from the item-by-item selection screen 55 to the ingredient display screen 60 (60a to 60c). The processing for this screen switching will be explained below.

When the user selects the second beauty essence from the left in the “featured products” 55c in FIG. 3, the name of this beauty essence is input into the cosmetic extraction means 31. The cosmetic extraction means 31 extracts the cosmetic information that matches the input product name from among the cosmetic information registered in the cosmetic database 41. The cosmetic extraction means 31 outputs the extracted cosmetic information as the detailed information of the first cosmetic (first cosmetic information) to the ingredient display screen generation means 32. In addition, the cosmetic extraction means 31 judges whether or not the first cosmetic information includes the active ingredient name.

If the first cosmetic information includes information on active ingredients, the cosmetic extraction means 31 extracts the cosmetic information from the cosmetic information registered in the cosmetic database 41, where at least part of the information on the active ingredients matches at least part of the active ingredients of the first cosmetic. The cosmetic extraction means 31 outputs the extracted cosmetic information to the ingredient display screen generation means 32 as detailed information on the second cosmetic (second cosmetic information).

The ingredient display screen generation means 32 generates screen information (ingredient display screen 60a) that has been formatted into a predetermined layout using the first cosmetic information and second cosmetic information input from the cosmetic extraction means 31. The output unit 12 then transmits the ingredient display screen 60a generated by the ingredient display screen generation means 32 to the user terminal 20. This ingredient display screen 60a is displayed in the content area 52 of the web page 50 displayed on the user terminal 20, as shown in FIG. 4.

The ingredient display screen 60 includes a first display area 61 for displaying first cosmetic information and a second display area 62 for displaying second cosmetic information, as shown in FIG. 4. The first display area 61 displays detailed information such as an appearance image 61a of the first cosmetic, a subcategory 61b, an active ingredient 61c, an ingredient name 61d, a product name 61e, a brand 61f, and a distributor.

When the first cosmetic product has multiple active ingredients, the second cosmetic product information extracted by the cosmetic product extraction means 31 is displayed and arranged side by side for each active ingredients in a simple display format in the second display area 62. In the simple display format, the second cosmetic product's appearance image 62a, subcategory 62b, active ingredient 62c, product name 62e, and brand 62f are displayed. In the ingredient display screen 60a shown as a specific example in FIG. 4, the first cosmetic product contains the active ingredients “salicylic acid” and “beta-glycyrrhetinic acid”, so cosmetic products that contain “salicylic acid” and cosmetic products that contain “beta-glycyrrhetinic acid” are displayed side by side separately as the second cosmetic products. The second cosmetic information for the part that exceeds the display area for each active ingredient is displayed by selecting the “view more” button 63. The user can easily find the cosmetic that share the active ingredients with the first cosmetic by looking at the ingredient display screen 60a.

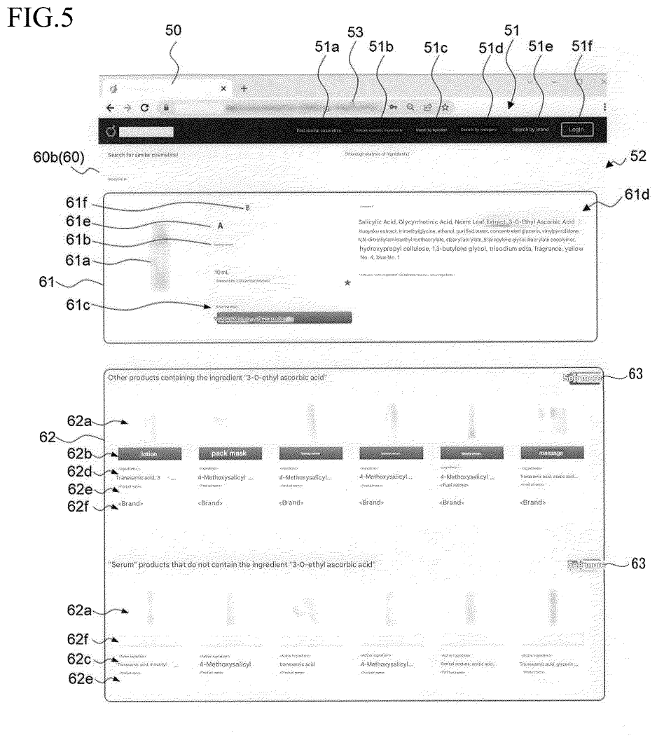

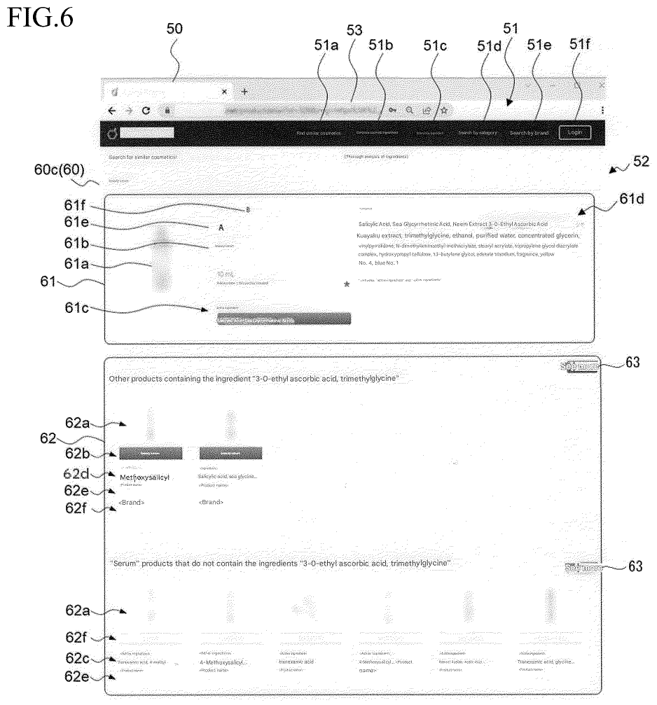

Each of the ingredient names 61d of the first cosmetic product can be selected using the input device 21 of the user terminal 20. The user can select one or more ingredient names. When the user selects an ingredient name by using the input device 21, the selected ingredient name is displayed (is highlighted) in white characters with a changed background color. At the same time, the content of the second display area 62 is rewritten according to the selected ingredient. For example, if the user selects “3-O-ethyl ascorbic acid” from the ingredient names 61d, the second display area 62 is rewritten as shown in FIG. 5. Furthermore, if the user selects “trimethylglycine,” the second display area 62 is rewritten as shown in FIG. 6. The generation of the ingredient display screens 60b and 60c will be explained below.

Each time a user selects an ingredient name, the selected ingredient name and the first cosmetic category are input into the cosmetic extraction means 31. The cosmetic extraction means 31 extracts the cosmetic information (“containing cosmetic information”) of the cosmetic that contain the input ingredient from the cosmetic information registered in the cosmetic database 41. Furthermore, the cosmetic extraction means 31 extracts the cosmetic information (“does not contain cosmetic information”) of the cosmetic that have the same category as the first cosmetic and do not contain the input ingredient from among the cosmetic information registered in the cosmetic database 41. The cosmetic extraction means 31 then outputs the extracted “contains cosmetic information” and “does not contain cosmetic information” to the ingredient display screen generation means 32.

The ingredient display screen generation means 32 generates screen information (ingredient display screens 60b, 60c) that replaces the contents of the second display area 62 with the “ingredient information which contains the ingredient” and “ingredient information that does not contain the ingredient” input by the cosmetic extraction means 31. The output unit 12 then transmits the ingredient display screens 60b, 60c generated by the ingredient display screen generation means 32 to the user terminal 20. These ingredient display screens 60b and 60c are displayed in the content area 52 of the web page 50 displayed on the user terminal 20.

When the user selects only the ingredient 61d “3-O-ethyl ascorbic acid”, as shown in FIG. 5, “3-O-ethyl ascorbic acid” is highlighted. At the same time, in the second display area 62, other cosmetic containing “3-O-ethyl ascorbic acid” and “beauty serums” that does not contain “3-O-ethyl ascorbic acid” are displayed side by side separately in a simple display format. Next, when the user selects the ingredient “trimethylglycine” (61d), “trimethylglycine” is also highlighted. At the same time, in the second display area 62, other cosmetic containing “3-O-ethyl ascorbic acid” and “trimethylglycine” and beauty serums that do not contain “3-O-ethyl ascorbic acid” and “trimethylglycine” are displayed side by side separately in a simple display format. For example, a user who has experienced that a cosmetic product containing “3-O-ethyl ascorbic acid” and “trimethylglycine” did not suit their skin can avoid purchasing not only the first cosmetic product, but also other cosmetic products containing “3-O-ethyl ascorbic acid” and “trimethylglycine” by looking at the ingredient display screen 60c.

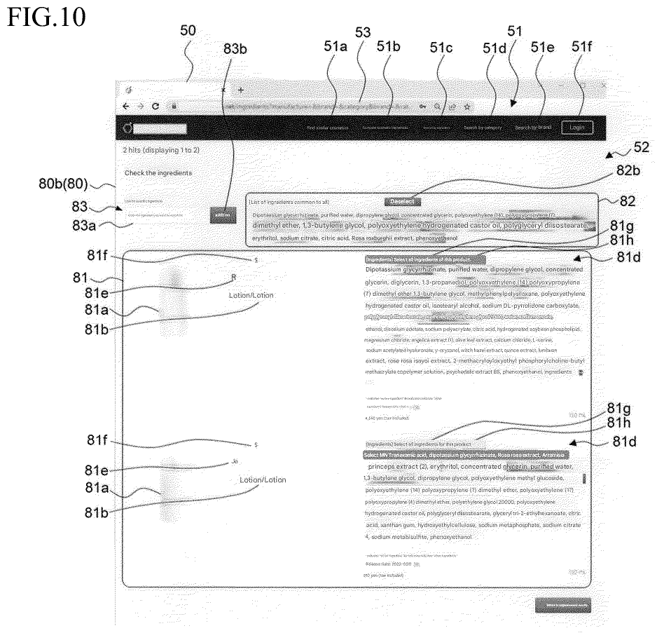

Next, by using FIGS. 7 to 11, we will explain an example where the user selects “lotion” in “search by category” 55e on the item-by-item selection screen 55 shown in FIG. 3. When the user selects “lotion,” the display in the content area 52 switches from the item-by-item selection screen 55 to the list display screen 70a shown in FIG. 7. If the user selects “compare Ingredients in detail” 71d after specifying multiple cosmetic on the list display screen 70, the display will switch from the list display screen 70 to the ingredient display screen 80 (80a, 80b), which allows the user to compare multiple cosmetic as shown in FIGS. 9 and 10. The following explains the process of this series of screen switching.

When the user selects “lotion” in “search by category” 55e in FIG. 3, the category “lotion” is input into the cosmetic extraction means 31. The cosmetic extraction means 31 extracts the cosmetic information that matches the category “lotion” which has been input from among the cosmetic information registered in the cosmetic database 41. The cosmetic extraction means 31 outputs the extracted cosmetic information to the list display screen generation means 33.

The list display screen generation means 33 generates screen information (list display screen 70a) which includes a table for displaying the cosmetic information extracted by the cosmetic extraction means 31 in a list, and then transmits the generated list display screen 70a to the user terminal 20. This list display screen 70a is displayed in the content area 52 of the web page 50 displayed on the user terminal 20, as shown in FIG. 7.

As shown in FIG. 7, the list display screen 70a includes a list display area 71 that displays a list of the cosmetic information extracted by the cosmetic extraction means 31, a common ingredient display area 72, a narrowing search unit 73, and a search condition setting unit 74. In the list display screen 70a, such a state that “skin care” is entered in the “large category” 74c of the search condition setting unit 74 and “lotion” is entered in the “small category” 74d thereof has been displayed, namely such a state that they have been set as search conditions has been displayed in advance.

Regarding the list display area 71, in addition to the table 71a that displays a list of the cosmetic information extracted by the cosmetic extraction means 31, there are display item buttons 71b provided for each item so that the user can select whether to display or not display the item in the table 71a, and a “compare ingredients in detail” button 71d for comparing ingredients between the multiple selected cosmetic in the table 71a. The user can specify the multiple cosmetic to be compared by checking the check boxes 71c provided for each cosmetic.

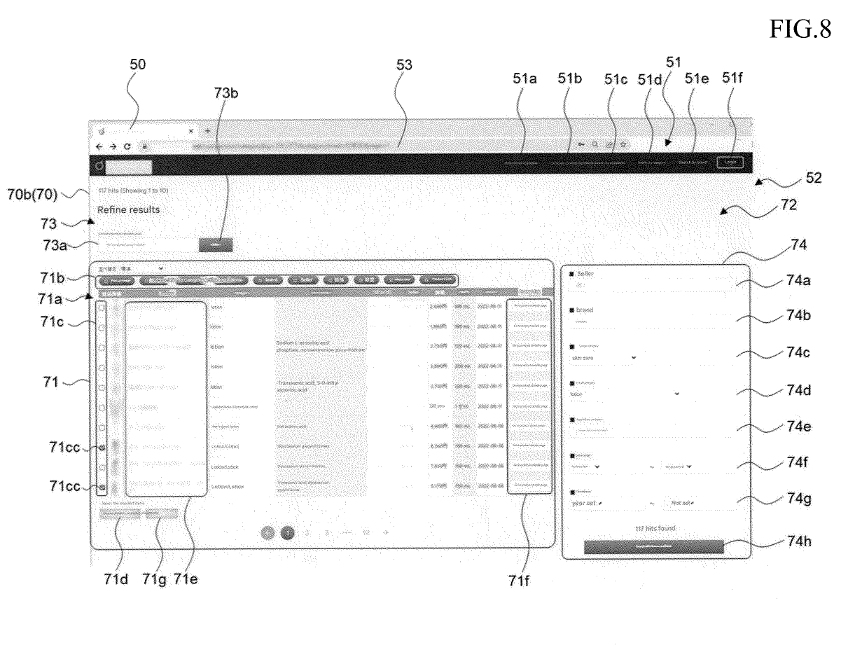

When the user selects “compare ingredients in detail” button 71d after specifying multiple cosmetic by placing a check mark 71cc in the check box 71c as shown in FIG. 8, the specified product name 71e is input into the cosmetic extraction means 31. The cosmetic extraction means 31 extracts the cosmetic information that matches the specified product name 71e, namely the cosmetic information of each of the cosmetic to be compared, from the cosmetic information registered in the cosmetic database 41. The cosmetic extraction means 31 outputs the extracted multiple cosmetic information about the cosmetic for comparison to the ingredient display screen generation means 32.

The ingredient display screen generation means 32 generates screen information (ingredient display screen 80a) that is laid out in a way which makes it easy to compare the multiple cosmetic information about the cosmetic which have been extracted by the cosmetic extraction means 31. The output unit 12 then transmits the ingredient display screen 80a generated by the ingredient display screen generation means 32 to the user terminal 20. This ingredient display screen 80a is displayed in the content area 52 of the web page 50 displayed on the user terminal 20, as shown in FIG. 9.

The ingredient display screen 80 (80a, 80b) includes a display area 81 for displaying multiple cosmetic product information side-by-side, a common ingredient display area 82, and a specific ingredient search unit 83. The display area 81 displays detailed information for each cosmetic product to be compared, including appearance images 81a, subcategories 81b, ingredient names 81d, product names 81e, brands 81f, distributors, prices, and capacities. The common ingredient display area 82 displays the ingredients that are common to all of the cosmetic being compared.

When the user selects the “select all” button 82a in the common ingredient display area 82 on the ingredient display screen 80a, the ingredient display screen generation means 32 updates the ingredient display screen 80a. The screen information after the update is the ingredient display screen 80b. In the ingredient display screen 80b, as shown in FIG. 10, all of the ingredient names in the common ingredient display area 82 and the ingredient names that are common to all cosmetic in the ingredients 81d of each cosmetic product displayed in the display area 81 are highlighted. On the ingredient display screen 80b, when the user selects the “deselect” button 82b in the common ingredient display area 82, the ingredient display screen generation means 32 updates the ingredient display screen 80b and returns it to the ingredient display screen 80a (shown in FIG. 9).

The specific ingredient search unit 83 has an input box 83a for entering ingredients and an “add” button 83b for adding the ingredient (specific ingredient) entered in the input box 83a and searching for it. When the user selects the input box 83a on the ingredient display screen 80, the ingredient names that can be entered are displayed in list format. The user enters the specific ingredient name in the input box 83a by selecting the ingredient name displayed in list format or entering the ingredient name directly. After entering a specific ingredient name, if the user specifies the “add” button 83b, the ingredient display screen generation means 32 will update the ingredient display screen 80 to a screen (not shown) where the specific ingredient name entered in the input box 83a is highlighted among the ingredients 81d of each cosmetic product displayed in the display area 81.

When the user selects a highlighted ingredient name on the ingredient display screen 80, the selected ingredient returns to its normal display (normal display) with black text on a normal background color. Also, when the user selects the “select all ingredients in this product” button 81g on the ingredient display screen 80, all of the ingredient names listed in the ingredients 81d of the selected cosmetic product are highlighted, and the ingredient names that are included in the ingredients 81d of other cosmetic and are common to the selected cosmetic product are also highlighted. In addition, when the user selects the “deselect” button 81h on the ingredient display screen 80, all of the ingredient names listed in the ingredients 81d of the cosmetic selected by the button 81h return to normal display, and the ingredient names of the ingredients 81d of the other cosmetic that are commonly included with the cosmetic selected by the button 81h also return to normal display.

As described above, by allowing the user to suitably avail either of selecting and deselecting the names of the ingredients 81d of each cosmetic, selecting and deselecting the names of the ingredients in the common ingredient display area 82, and searching for specific ingredients by using the specific ingredient search unit 83, the user can easily compare the ingredients of the cosmetic being compared. For example, a user who is allergic to a certain ingredient can find the cosmetic containing the allergen from among the cosmetic of interest and avoid purchasing these cosmetic. For example, a user can look at the ingredients, price, and capacity of multiple cosmetic of interest and find cosmetic with similar ingredients and good cost performance.

Returning to FIG. 7, we will explain the functions that a user can perform on the list display screen 70a in addition to comparing the ingredients of multiple cosmetic.

In Table 71a, all items are displayed, and all display item buttons 71b are displayed with highlighting. When the user selects one of these highlighted display item buttons 71b, the list display screen generation means 33 hides the selected item and returns the display item button 71b to normal display. In addition, if the user selects a “hide” button 71g after specifying the cosmetic by entering a check mark 71cc in the check box 71c, as shown in FIG. 8, the list display screen generation means 33 will rewrite the state in which the checked cosmetic are excluded (not shown in the figure).

When the user selects a “product details page” 71f (link) provided for each cosmetic product line in Table 71a, the ingredient display screen generation means 32 generates the ingredient display screen 60a. In addition, for cosmetic that are not listed in the “featured products” 55c of the item-by-item selection screen 55, the user can display the ingredient display screen 60a for that cosmetic by first specifying a category in the “search by category” 55e of the item-by-item selection screen 55, and then going through the list display screen 70a that is displayed by specifying a category. After the ingredient display screen 60a is displayed on the user terminal 20, process will be as described above.

The common ingredient display area 72 displays the ingredients that are common to all of the cosmetic displayed in Table 71a. In the specific example shown in FIG. 7, there are no ingredients that are common to all of the cosmetic, so that the common ingredient display area 72 is blank.

The narrowing search unit 73 has an input box 73a for entering the ingredients to be excluded, and an “add” button 73b for adding the exclusion of the ingredients entered in the input box 73a and searching for them. When the user selects the input box 73a on the list display screen 70a, the names of the ingredients that can be input are displayed in list format. The user inputs the ingredients they want to exclude by selecting the names of the ingredients displayed in list format in the input box 73a or by directly inputting the names of the ingredients. When the user specifies the “add” button 73b after inputting the ingredients they want to exclude, the list display screen generation means 33 rewrites Table 71a in a state where the cosmetic containing the ingredients they want to exclude have been excluded (not shown in the figure).

The search condition setting unit 74 has a search condition input box and a “search with these conditions” button 74h that executes a search with the conditions entered in the search condition input box. The search condition setting unit 74 has input boxes for the following search conditions: “distributer” 74a, “brand” 74b, “major category” 74c, “minor category” 74d, “ingredients” 74e, “price range” 74f, and “year of release” 74g. The list display screen 70a is a list display screen that is displayed when the user selects “lotion” in “search by category” 55e on the item-by-item selection screen 55 shown in FIG. 3. Therefore, “skin care” is input in “large category” 74c and “lotion” is input in “small category” 74d of the search condition setting unit 74, namely they are displayed in a state where they are set as search conditions.

When the user selects the “search with these conditions” button 74h after entering additional input fields other than “large category” 74c and “small category” 74d, the list display screen generation means 33 will rewrite Table 71a, so that it only consists of cosmetic that match the additional input conditions (not shown). In addition, if there are any ingredients common to all of the cosmetic listed in the table after it has been rewritten, the list display screen generation means 33 will also rewrite the common ingredient display area 72.

If the user selects the “search by these conditions” button 74h after changing the contents of the “large category” 74c or “small category” 74d, the changed contents will be output to the cosmetic extraction means 31. The cosmetic extraction means 31 performs a search and extraction based on the contents entered in the input frame of the search condition setting unit 74, and outputs the extracted cosmetic information to the list display screen generation means 33. The list display screen generation means 33 generates screen information (list display screen 70c) that includes a table for displaying the cosmetic information extracted by the cosmetic extraction means 31 in a list. For example, if the user leaves the “large category” 74c or “small category” 74d blank, enters “tranexamic acid” in the “Ingredients contained” 74e, and then selects the “search with these conditions” button 74h, the list display screen 70c shown in FIG. 11 will be generated by the list display screen generation means 33 and displayed on the user terminal 20.

The list display screen 70c shown in FIG. 11 is also displayed on the user terminal 20 when the user selects “tranexamic acid” in the “featured ingredients” 55a or “tranexamic acid” in the “search by active ingredients” 55b on the item-by-item selection screen 55 shown in FIG. 3. In addition, users can search for cosmetic containing ingredients of interest not only from “featured Ingredients” 55a or “search by active Ingredients” 55b, but also from the search condition setting unit 74 of the list display screen 70.

### Second Embodiment

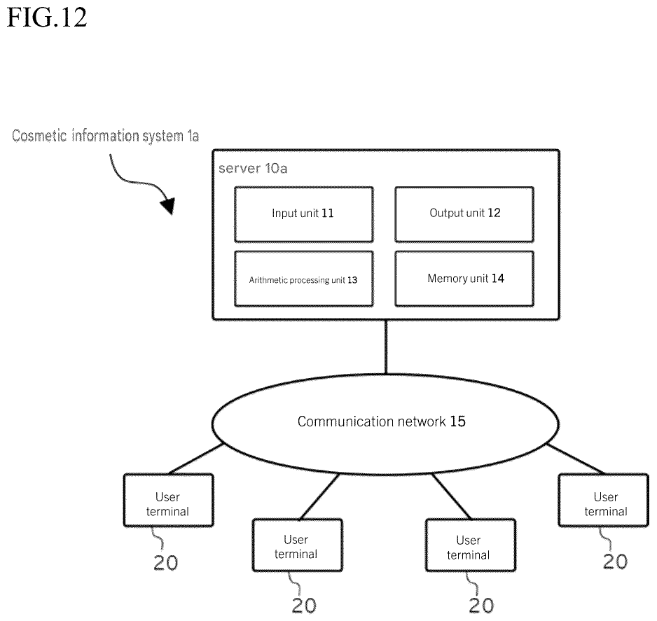

FIGS. 12 to 18 are used to explain the second embodiment of the chemical information system la. In the following explanation of the second embodiment, the points that differ from the first embodiment of the chemical information system 1 are explained, and the explanation of the points in common is omitted. In the chemical information system la, the items with the same symbols as those of the chemical information system 1 indicate means having the same functions.

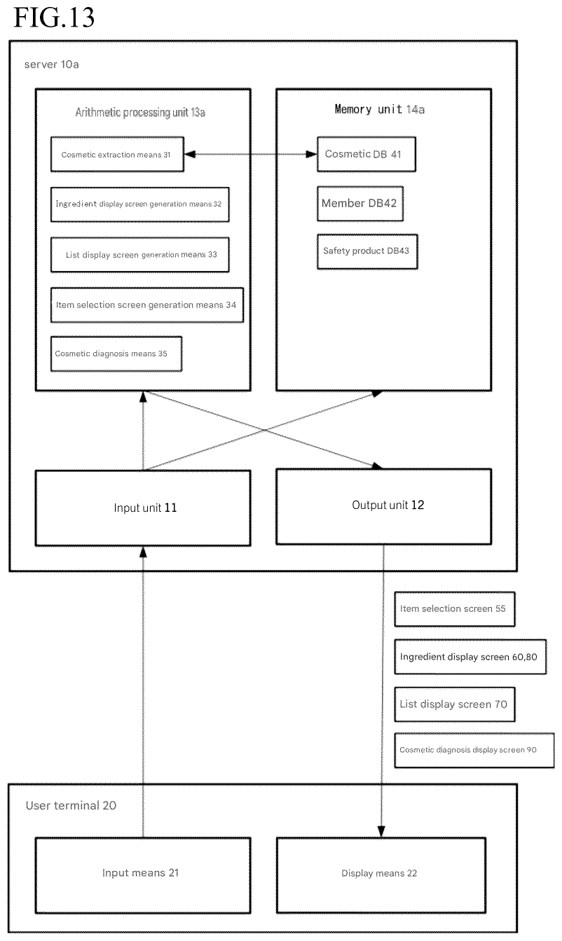

By using the block diagram shown in FIG. 13, the configurations of the arithmetic processing unit 13a and the memory unit 14a of the server 10a will be explained in detail. The arithmetic processing unit 13a has a cosmetic extraction means 31, an ingredient display screen generation means 32, a list display screen generation means 33, a item-by-item selection screen generation means 34, and a cosmetic diagnosis means 35. The memory unit 14a has a cosmetic database (cosmetic DB) 41, a member database (member DB) 42, and a safe product database (safe product DB) 43.

First, we will explain the memory unit 14a. The cosmetic database 41 and the member database 42 are the same as those held by the memory unit 14, so that we will only explain the safe product database 43.

The safe product database 43 has detailed information (cosmetic information) disclosed by the distributors of cosmetic in regard to cosmetic products and the like that are recognized as being highly safe on the market. The cosmetic diagnosis means 35 to be described later refers to the safe product database 43 in order to narrow down the cosmetic to be extracted. The products to be registered in the safe product database are selected by the system administrator based on market information. The system administrator registers the cosmetic information for the selected products in the safe product database 43.

Next, we will explain the arithmetic processing unit 13a. The cosmetic extraction means 31, the ingredient display screen generation means 32, the list display screen generation means 33, and the item-by-item selection screen generation means 34 are the same as those possessed by the arithmetic processing unit 13, so that we will only explain the cosmetic diagnosis means 35.

Cosmetic diagnosis means 35 executes a cosmetic diagnosis that checks the ingredients that the user is not good at through online counseling for the user, generates the results of the cosmetic diagnosis, and generates screen information (cosmetic diagnosis report screen 95) for displaying the generated cosmetic diagnosis results in a predetermined layout. In addition, cosmetic diagnosis means 35 displays user input screens 90 (90a, 90b, 90c) for counseling for the user. The cosmetic diagnosis means 35 then uses the information entered in the user input screen 90 as a key to search for cosmetic information registered in the cosmetic database 41 and/or the safe product DB 43, and generates the cosmetic diagnosis results.

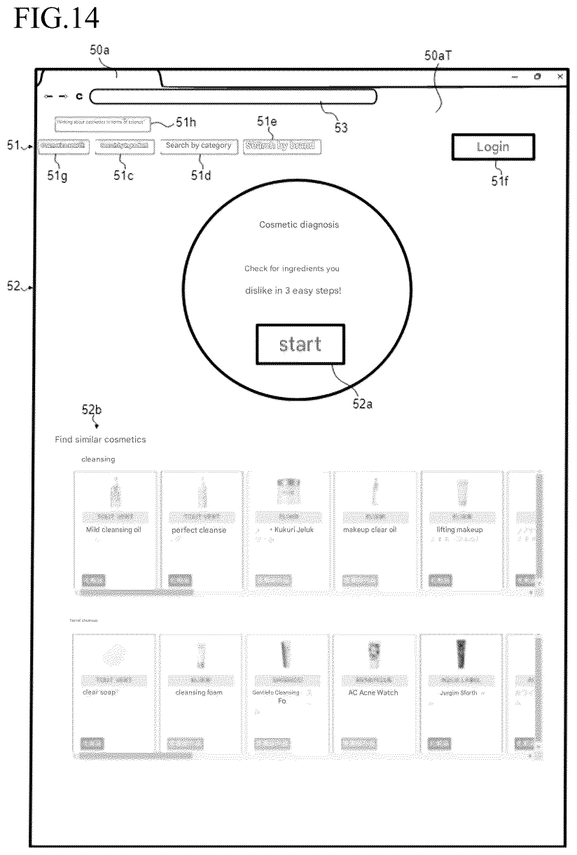

FIGS. 14 to 18 are specific examples of screens displayed on the display device of the user terminal 20. The second embodiment of the cosmetic information system 1a of the present invention will be explained below by using these specific examples of screens.

On the user terminal 20, when the user starts up a web browser and enters a predetermined URL in the URL input field 53, the web page 50a of the server 10a is displayed in the web browser. The web page 50a includes a menu bar 51 and a content area 52.

On the top page 50aT of the web page 50a shown in FIG. 14, when the user selects the login button 51f in the menu bar 51, a login screen (not shown) is displayed. By entering a member ID and password on this login screen, the user can log in and thereby receive services from the cosmetic information system 1a.

The menu bar 51 is always displayed on all pages of the web page 50a. The menu bar 51 has selection items for different purposes, such as “cosmetic search” 51g, “search by ingredients” 51c, “search by category” 51d, and “search by brand” 51e. When the user selects one of these selection items, the display screen is shifted to another part of the page or to another page according to the purpose.

The site name 51h, which indicates the name of the web page 50a, is always displayed on all pages of the web page 50a. By clicking on the site name 51h, it is possible to return to the top page 50aT from other pages.

On the content area 52 of the top page 50aT, the “cosmetic diagnosis” start button 52a and “find similar cosmetic” 52b are displayed. When a product displayed in “find similar cosmetic” 52b on the top page 50aT is selected, the display in the content area 52 switches to the ingredient display screen 60 (60a to 60c). The processing for switching this screen is the same as in the first embodiment.

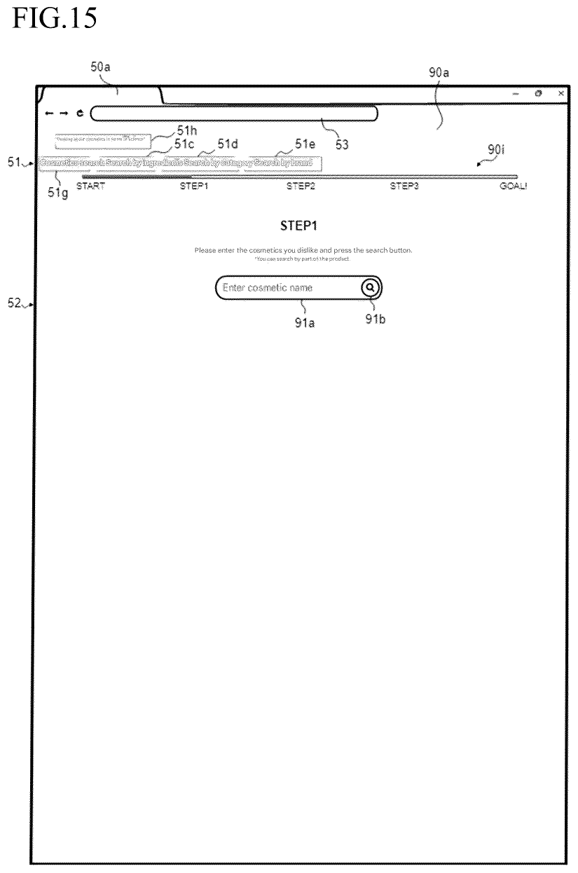

When the user selects the start button 90a on the top page 50aT, the screen transitions to the user input screen 90a of STEP 1 shown in FIG. 15, and the “cosmetic diagnosis” will start which allows the user to check the ingredients they are not good at.

The “cosmetic diagnosis” progresses in three steps. For each step, the user input screens 90a, 90b, and 90c for counseling the user are successively displayed on the screen of the user terminal 20. Then, when the user has responded to the three steps, the cosmetic diagnosis result is generated by the cosmetic diagnosis means 35, and the cosmetic diagnosis report screen 95 is displayed on the screen of the user terminal 20. The progress of the steps is displayed in the step display 90i at the top of the content area 52 on the user input screens 90a, 90b, and 90c, and on the cosmetic diagnosis report screen 95.

The content area 52 of the user input screen 90a for STEP 1 shown in FIG. 15 includes a difficult product search column 91a. The difficult product search column 91a includes an input column for entering the name of a difficult cosmetic or part of the name of a cosmetic that the user are not good at, and a search execution button 91b for executing a search after entering the name of a cosmetic and the like in the input column.

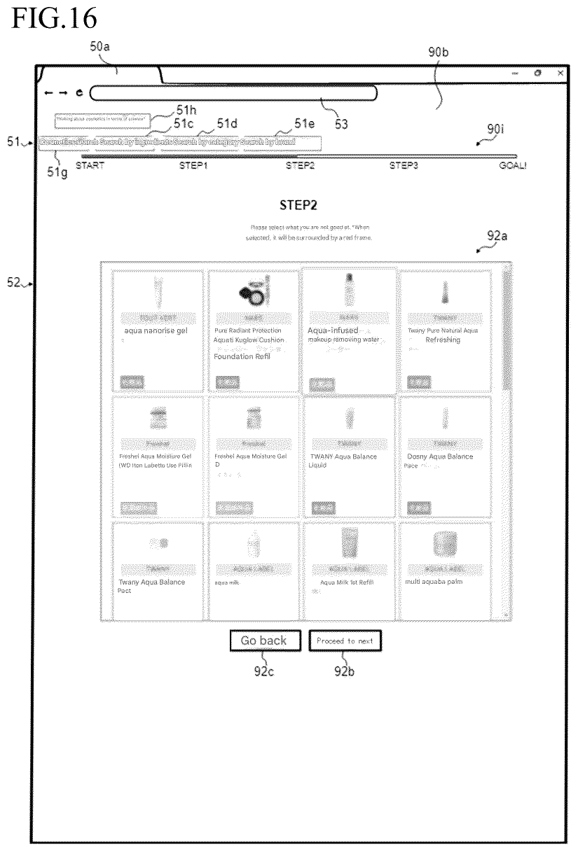

When the user clicks on the “search” button 91b, the cosmetic diagnosis means 35 extracts the cosmetic information that matches the information, in which at least a part of the product name is input, from the cosmetic information registered in the cosmetic database 41. The cosmetic diagnosis means 35 further generates the screen information (user input screen 90b of STEP 2) for the user to select and input the product that they are not good at from the extracted products. The screen of the user terminal 20 then changes to the user input screen 90b of STEP 2 shown in FIG. 16.

The content area 52 of the user input screen 90b of STEP 2 shown in FIG. 16 includes a “difficult product selection column” 92a for selecting products that the user is not good at, in which a list of product identification information such as product names is displayed in a predetermined layout within the cosmetic information of the products extracted by the cosmetic diagnosis means 35. In the “difficult product selection column” 92a, each product identification information is surrounded with a frame. When a user clicks on and selects a product identification information displayed in the “difficult product selection column” 92a, a color of the frame of the selected product identification information changes (e.g., it becomes a red border), and the selection state is set. When a user clicks on the selected product identification information again, the color of the frame of the product identification information returns to the original state, and the non-selection state is set.

The content area 52 of the user input screen 90b of STEP 2 includes a “next” button 92b and a “back” button 92c. When the user clicks the “next” button 92b, the product corresponding to the selected product identification information is confirmed as the user's “difficult product”. The confirmed “difficult product” can be registered in the member database 42 as the user's member information. When the user clicks the “back” button 92c, it returns to the user input screen 90a of STEP 1.

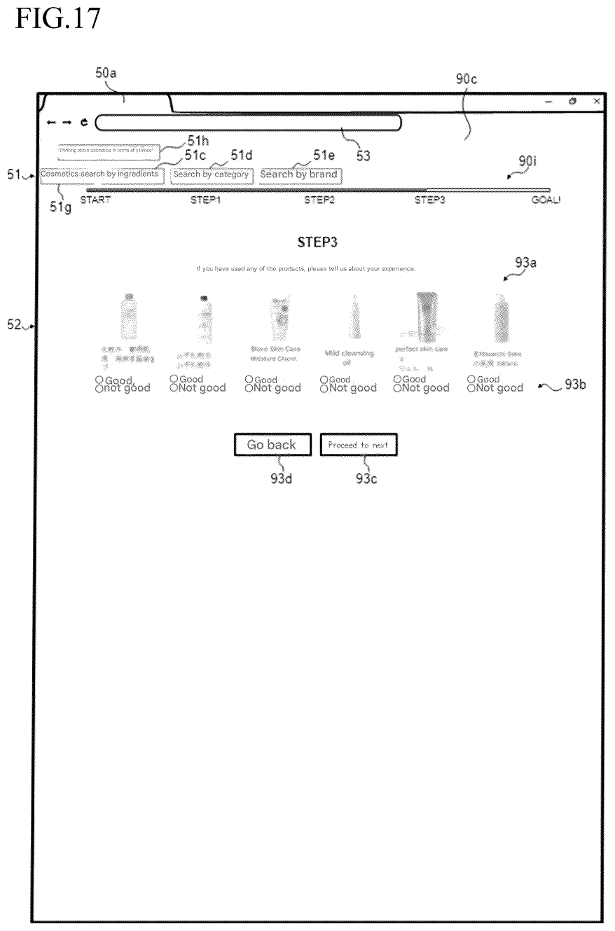

When the user clicks the “next” button 92b, the cosmetic diagnosis means 35 randomly extracts at least one cosmetic information from the cosmetic information registered in the safe product database 43. The cosmetic diagnosis means 35 further generates screen information (user input screen 90c of STEP 3) for entering “how it feels when you have used it” for the extracted product. Subsequently, the screen of the user terminal 20 then changes to the user input screen 90c of STEP 3 shown in FIG. 17.

The content area 52 of the user input screen 90c of STEP 3 shown in FIG. 17 includes a “column for investigating the feel of use” 93a, in which a list of product identification information such as product names and the like is displayed in a predetermined layout within the cosmetic information of the product extracted by the cosmetic diagnosis means 35. The “column for investigating the feel of use” 93a includes a column for inputting the feel of use 93b for each product identification information. In the specific example shown in FIG. 17, the user can select “good” or “not good” to enter in the column for inputting the feel of use 93b. If the user has never used the product displayed in the “column for investigating the feel of use” 93a, or if the user does not want to answer the “column for investigating the feel of use” 93a, the user does not have to enter anything in the column for investigating the feel of use” 93a.

The content area 52 of the user input screen 90c of STEP 3 includes a “next” button 93c and a “back” button 93d. When the user clicks the “next” button 93c, the product for which a positive response (input of “good” in the specific example) was made in the column for inputting the feel of use 93b is determined as the user's “safe cosmetic”. The confirmed “safe cosmetic” can be registered in the member database 42 as the user's member information. If the user clicks the “back” button 93d, it returns to the user input screen 90b of STEP 2.

When the user clicks the “next” button 93c, the cosmetic diagnosis means 35 generates “safe ingredient information” such as the ingredient names of at least one “safe ingredient” based on the cosmetic information that the confirmed “safe cosmetic” is contained. The “safe ingredients” correspond to safe general-purpose solvents (e.g., water) and safe additives that many products contain. The “safe ingredient information” can include the maximum concentration and usage method at which the “safe ingredients” can be used safely.

In addition, the cosmetic diagnosis means 35 classifies the ingredients (“candidate ingredients”) contained in the “difficult products” that have been confirmed on the user input screen 90b of STEP 2, based on whether they are contained in several “difficult products” in common. In the classification of the candidate ingredients, the “safe ingredients” whose ingredient names are included in the “safe ingredient information” can be excluded. By doing this, it is possible to narrow down the “candidate ingredients to be avoided” so that it does not become unnecessarily much.

In addition, the cosmetic diagnosis means 35 searches for cosmetic information that does not contain “candidate ingredients to be avoided” as ingredients, from among the cosmetic information registered in the cosmetic database 41, by using “candidate ingredients to be avoided” as a key, and extracts the product names of the cosmetic information that is a hit (“candidate safe products”).

In addition, the cosmetic diagnosis means 35 generates the cosmetic diagnosis results. The cosmetic diagnosis results include the results of classifying the “candidate ingredients to be avoided” based on how many “difficult products” they are commonly included, as well as the results of extracting the “candidate safe products”. The “candidate ingredients to avoid” are those that are excluded from the “safe ingredients” whose names are included in the “safe ingredient information.” In other words, they are “ingredients which are common to the N products that are difficult to use and are not included in the products which have a good feel when used” (N is the number of confirmed “difficult products”).

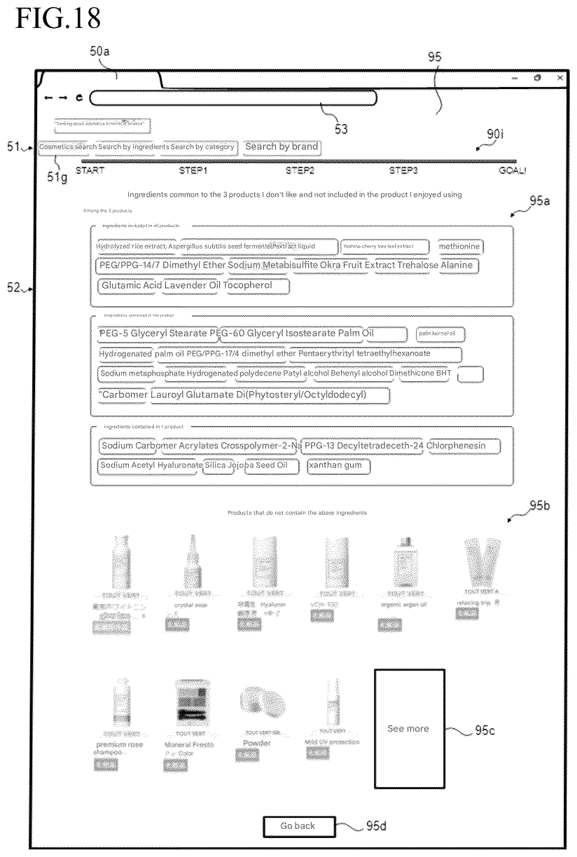

In addition, the cosmetic diagnosis means 35 generates screen information (cosmetic diagnosis report screen 95) for displaying the generated cosmetic diagnosis results in a predetermined layout. The screen of the user terminal 20 then transitions to the cosmetic diagnosis report screen 95 shown in FIG. 18.

In addition, the cosmetic diagnosis means 35 generates screen information (cosmetic diagnosis report screen 95) for displaying the generated cosmetic diagnosis results in a predetermined layout. The screen of the user terminal 20 then transitions to the cosmetic diagnosis report screen 95 shown in FIG. 18.

The content area 52 of the cosmetic diagnosis report screen 95 shown in FIG. 18 includes the “candidate for difficult ingredient” column 95a and the “candidate for safe product” column 95b.

In the “candidate for difficult ingredient” column 95a, the ingredients contained in one or more (N) “difficult products” determined in STEP 2, are classified depending on how many products they are contained and then displayed in a list. “Safe ingredients” such as safe general-purpose solvents (e.g., water) and safe additives may also be included in the determined “difficult products”. However, the ‘candidate difficult ingredients’ list 95a excludes “safe ingredients”, so that the user can easily recognize the actual “candidate difficult ingredients”.

In the “safe product candidate” column 95b, a list of product identification information such as product names of products that do not contain the “difficult ingredient candidates” listed in the “difficult ingredient candidate” list 95a is displayed in a predetermined layout. If the number of “safe product candidates” exceeds a predetermined number, a “see more” button 95c is displayed in the “safe product candidate” column 95b. Clicking the “see more” button 95c can display “safe product candidates” that are not displayed.

When a product displayed in the “candidate safe products” column 95b is selected, the display in the content area 52 switches to the ingredient display screen 60 (60a to 60c). The processing for switching this screen is the same as in the first embodiment.

The content area 52 of the cosmetic diagnosis report screen 95 includes a “back” button 95d. When the user clicks the “back” button 95d, the user returns to the user input screen 90c of STEP 3. In addition, by clicking on the site name 51h, the user can redo the “cosmetic diagnosis”.

The chemical information system la of the second embodiment may be modified as follows.

When registering a product in the safe product database 43, it may be possible to automatically cancel the registration by referring to the member database 42. Specifically, if a product registered in the safe product database 43 is registered as a “difficult product” in more than a predetermined number of member information, it may be possible to delete the product from the safe product database 43.

When registering products in the safe product database 43, a level of safety and/or a class corresponding to the attributes of the member (physique, age, allergies, and the like) is added based on market recognition and/or member information. Then, when extracting the cosmetic information displayed at the “column for investigating the feel of use” 93a in the user input screen 90c of STEP 3, the cosmetic diagnosis means 35 may reflect the level of safety and the class.

The cosmetic diagnosis results generated by the cosmetic diagnosis means 35 may be registered in the member database 42 together with the date and time information of the diagnosis. For example, when the user next uses the chemical information system 1a, the system may present the “candidate ingredients to avoid” and “candidate safe products” based on agreement and/or disagreement with the “candidate ingredients to avoid” and “candidate safe products” registered in the member database 42. In addition, it is also possible to refer to the “candidate ingredients to avoid” and “candidate safe products” registered in the member database 42 and extract the cosmetic information to be displayed in the “column for investigating the feel of use” 93a.

In addition, it is also possible to use AI technology or generated AI technology in extracting the “candidate ingredients to avoid”, “candidate safe products”, and the cosmetic information to be displayed in the “column for investigating the feel of use” 93a.

In the first embodiment of the chemical information system 1, if the user already knows the “ingredients to avoid”, they can easily and quickly find out whether or not a product they are interested in or a new product is suitable for them. However, if the user does not know the “ingredients to avoid”, it is somewhat more difficult to find a product that is suitable for them. On the other hand, in the second embodiment of the chemical information system la, the user can select a product from the “safe product candidates” presented through the three-step online counseling, so that they can easily and quickly find a product that suits them.

### Modified Embodiment

In the above-mentioned first and second embodiments, we have described a system in which the screen information generated and transmitted by the web server, server 10, 10a, is displayed on the display means 22 of the user terminal 20 on which a web browser is installed, but the cosmetic information system of the present invention can also be configured as follows.

The cosmetic information system of the present invention may be implemented by a program (application) that can be installed on the user terminal 20 to realize at least one of the functions of the ingredient display screen generation means, the list display screen generation means, the item-specific selection screen generation means, and the cosmetic extraction means. In this case, it is sufficient to configure the system so that only the functions that cannot be implemented by the program (application) that can be installed on the user terminal 20 are implemented by the server 10, 10a or the program installed on the server 10, 10a. For example, the functions of the ingredient display screen generation means, list display screen generation means, and item-specific selection screen generation means can be implemented by an application that can be installed on the user terminal 20, and the function of the cosmetic extraction means 31 can be implemented by the server 10, 10a or a program installed on the server 10, 10a. In this case, the search items sent from the application on the user terminal 20 can be searched by using the cosmetic extraction means 31 of the server 10, 10a, and the search results can be sent to the application on the user terminal 20.

In addition, in the system of the above-mentioned embodiment, the cosmetic database can be provided on a server other than the server 10, and the cosmetic extraction means 31 of the server 10 can access the cosmetic database on the other server and perform searches.

In the above first and second embodiments, we have described a system that uses member information only for logging in, but the cosmetic information system of this invention can also be a system with the following configuration, including attribute information such as the member's age, gender, and residential area, as well as search history and product reviews in the member information.

By reflecting attribute information such as the member's age, gender, and residential area, as well as search history information, in the search items that can be selected and displayed on the item-by item selection screen 55, such as “featured ingredients” 55a, “search by active ingredients” 55b, “featured products” 55c, and “find similar cosmetic” 52b, the search results can be customized for each members. For example, the system administrator can set up multiple search options in advance, and then automatically select from among these options based on the member's attribute information and search history.

Further, it is also possible to configure the system so that the level of attention to the ingredients and products can be calculated based on the product reviews by members. Based on the calculated level of attention, it is also possible to configure the system so that the search items that can be selected for “featured Ingredients” 55a and “featured products” 55c on the item-by-item selection screen 55 can be automatically set. In addition to the product reviews by members, the level of attention can also be calculated by using the frequency of appearance on websites, SNS, and TV commercials.

In the above embodiment, the selected ingredient name is displayed in a way that makes it distinguishable from other ingredients by displaying it in white letters with a changed background color (highlight display). However, the method of displaying the selected ingredient name in a way that makes it distinguishable from other ingredients is not limited to the highlight display. For example, instead of the highlight display, the color of the selected ingredient name can be changed, or the selected ingredient name can be underlined, enclosed, or given a mark.

The above describes an embodiment of the present invention, but the present invention is not limited to the above embodiment, and various modifications are possible within the scope of the technical ideas described in the claims, as well as in the description and drawings.

For example, the above embodiment explains the comparison of ingredients using cosmetic as an example, but the products targeted by the present system are not limited to specific cosmetic, and can be applied to all cosmetic as defined in the present application.

The above embodiment shows a case where a search and extraction is performed by using the names of the ingredients contained in cosmetic, but it is also possible to make it so that, for example, other ingredient names that contain the same ingredients (elements) or ingredients that are displayed under different names with similar properties can also be searched for and extracted (displayed) as related ingredients. This makes it possible for users to search for their favorite or least favorite ingredients more comfortably.

In addition, when displaying the results of a search or extraction, it may be possible to sort the display by price (expensive/cheap), release date (new/old), number of ingredients contained (many/few), evaluation (high/low word-of-mouth evaluation score), and the like.

It is also possible to use the ingredients contained in cosmetic and other goods (products) as a basis for extracting and displaying recommended products by using AI (machine learning) or the behavioral history of the target user. For example, by using the full ingredient data for each product, it is possible to perform an exclusion search by selecting (one or more) specific ingredients for people with allergies or those with skin that does not suit certain ingredients. On the other hand, it is also possible to narrow down the products by selecting multiple options if you want to narrow down the search by your favorite ingredients.

In addition, on the product detailed page, it may be possible to display real-time recommendations of similar products based on their ingredients. For example, if a certain ingredient is selected for all the ingredients in a particular product, that ingredient will be highlighted, and products containing the selected ingredient will be displayed as recommendations. In this case, it is also possible to select multiple ingredients. At the same time, it may also be possible to display recommendations of products in the same category that exclude the selected ingredients. As for the exclusion, it may be possible to prevent display if any of the multiple selected items are included.

It may also be possible to judge and display matching degree between the ingredients of the cosmetic registered by the user and the ingredients of the target cosmetic. For example, when a specific product is selected from the external import function, such as the product photo or barcode, or the search function, it may be possible to display the degree of similarity between that product and the products registered by the user. Further, it may also be possible to display the relevance degree of that product in the user's “favorite products and ingredients” or “difficult products and ingredients” linked to the membership registration information. According to the information, the percentage of products that contain ingredients that the user dislikes can be understood, and it becomes possible to judge to what extent the product is suited to the user.

In addition, by analyzing the data stored in the member database 42, based on the information such as not only ingredients of cosmetic, but also nationalities, languages, skin qualities, genders and/or ages of the user who is using the cosmetic, it is also possible to reflect in the display of search results such a comprehensive judgment that what kind of products people similar to the user in question having checked, or what kind of other products people who have viewed the same product having purchased have been comprehensively considered. Besides, it is also possible to register the cosmetic used by the user together with information such as the user's physical conditions, such as weight, whether they are dieting, whether they are doing muscle training, whether they are doing any daily exercise, their basal body temperature, and their physiological phenomenon. In addition, it is also possible to record simple comments and other textual information for the cosmetic that are registered. Further, it is also possible to provide a function that allows an AI chatbot or a person to ask about cosmetic concerns or questions in chat format, narrow down the cosmetic in question one question at a time, and make recommendations to the user. In addition, it is also possible to provide an evaluation axis for the safety and reliability of the cosmetic that are displayed, and to display a score or mark corresponding to the relevant evaluation axis, so that the user can use this as one of the criteria for choosing a product.

In the above embodiment, when an ingredient name is entered in the input box 83a of the specific ingredient search unit 83 shown in FIG. 9, the specific ingredient name entered is highlighted (in the display area 81 or the common ingredient display area 82). In addition to this, or instead of this, it is also possible to have the ingredients similar to the specific ingredient name entered (similar ingredients) highlighted as candidates. For example, if “alcohol” is entered as an ingredient name in the input box 83a, similar ingredients such as ethanol may be highlighted as candidate of similar ingredients, and it may be possible to select them all at once.

### EXPLANATIONS OF REFERENCE NUMERALS

1, 1a cosmetic information system (cosmetics information system)
10, 10a server
11 input unit
13, 13a arithmetic processing unit
14, 14a memory unit
15 communication network
20 user terminal
21 input means
22 display means
31 cosmetic extraction means (cosmetics extraction device)
32 ingredient display screen generation means
33 list display screen generation means
34 item-by-item selection screen generation means
35 cosmetic diagnosis means
41 cosmetic database (cosmetic DB) (cosmetics database)
42 member database (member DB)
50, 50a web page
50aT top page
55 item-by-item selection screen
60 (60a, 60b, 60c) ingredient display screen
70 (70a, 70b, 70c) list display screen
80 (80a, 80b) ingredient display screen
90 (90a, 90b, 90c) user input screen

1. A cosmetic information system comprising:
means for generating an ingredient display screen that indicates information on cosmetic, which includes information on the names of ingredients corresponding to the names of at least cosmetics;
an output unit that outputs the data of the ingredient display screen generated by the ingredient display screen generation means to a display means for displaying the ingredient display screen,
an input unit that accepts input of selected items selected on the ingredient display screen displayed on the display means,
cosmetic extraction means that accesses a cosmetic database in which the cosmetic information is registered for each cosmetic and extracts the cosmetic information corresponding to the selected items accepted by the input unit from the cosmetic information registered in the cosmetic database,
wherein
when at least one of the ingredient names contained in the first cosmetic information, which is one of the cosmetics information displayed on the ingredient display screen displayed on the display means, is selected, the selected ingredient name is input to the cosmetic extraction means as the selected item,
the cosmetic extraction means, based on the selected item input to the cosmetic extraction means, extracts the second cosmetic information which is the cosmetic information other than the first cosmetic information, from the cosmetics information registered in the cosmetic information database, and
the ingredient display screen generation means generates another ingredient display screen that has the first cosmetic information and the second cosmetic information extracted by the cosmetic extraction means, and
the output means outputs the data of another ingredient display screen to the display means.

2. The cosmetic information system according to claim 1, further comprising:
item-by-item selection screen generating means for generating an item-by-item selection screen including at least one of a category, a brand, a predetermined ingredient, and a predetermined product as the selected items, with each of the selected items including at least one search item;
each of the cosmetic information further includes the category and/or brand to which each cosmetic belongs;
when at least one of the search items is selected on the item-by-item selection screen displayed on the display means, the cosmetic extraction means extracts cosmetic information corresponding to the search item from the cosmetic information registered in the cosmetic database.

3. The cosmetic information system according to claim 2, wherein the ingredient display screen generation means generates an ingredient display screen indicating the cosmetic information as the first cosmetic information corresponding to the search item extracted by the cosmetic extraction means.

4. The cosmetic information system according to claim 2,
further comprising a list display screen generation means that generates a list display screen which displays product names of the cosmetics included in the cosmetic information corresponding to the search items extracted by the cosmetic extraction means in tabular form,
when one of the links of the cosmetic whose product names are displayed on the list display screen displayed on the display means is selected,
the ingredient display screen generation means sets the cosmetic information of the selected cosmetics as the first cosmetic information and generates an ingredient display screen that shows the cosmetic information.

5. The cosmetic information system according to claim 4,
when at least two of the cosmetics are selected, whose product names are displayed on the list display screen displayed by the display means,
the ingredient display screen generation means generates an ingredient display screen that shows the cosmetic information of the at least two selected cosmetics for each cosmetic.

6. The cosmetic information system according to claim 5, wherein the ingredient display screen generation means generates an ingredient display screen with a common ingredient display unit that displays the ingredients which are common to all of the displayed cosmetics.

7. The cosmetic information system according to claim 5, wherein
when the ingredient display screen that shows the cosmetic information of each cosmetics for at least two of the selected cosmetics is displayed on the display means,
if at least one of the ingredient names shown on the ingredient display screen displayed on the display means is selected,
the ingredient display screen generation means displays the selected ingredient name and the same ingredient name as the selected ingredient name in a manner that allows their names to be distinguished from other ingredients.

8. The cosmetic information system according to claim 4, wherein
the list display screen has an exclusion ingredient input unit that can be used to input exclusion ingredients, which are ingredients that user wants to exclude from the ingredients contained in the cosmetics,
when the exclusion ingredient is input in the exclusion ingredient input unit,
the list display screen generation means narrows down the cosmetic information to the information of the cosmetics that do not contain the excluded ingredients, out of the cosmetic information corresponding to the selected items, and displays the narrowed-down cosmetic information on the list display screen,

9. The cosmetic information system according to claim 1, wherein
when at least one of the ingredient names included in the first cosmetic information on the ingredient display screen displayed by the display means is selected,
the ingredient display screen generation means displays the selected ingredient name in a manner that allows the name to be distinguished from other ingredients.

10. (canceled)
